(19) United States
(12) Patent Application Publication
(10) Pub. No.: US 2026/0330301 A1
(43) Pub. Date: Oct. 22, 2026

(54) APPARATUS AND METHOD FOR DECENTRALIZED FEDERATED LEARNING

(71) Applicant: ELECTRONICS AND TELECOMMUNICATIONS RESEARCH INSTITUTE, Daejeon (KR)

(72) Inventors: Hun-Soon LEE, Daejeon (KR); Myung-Cheol LEE, Daejeon (KR)

(21) Appl. No.: 19/387,009

(22) Filed: Nov. 12, 2025

(30) Foreign Application Priority Data
Apr. 22, 2025 (KR) 10-2025-0052040

(51) Int. Cl. G06N 20/00

(52) U.S. Cl. CPC G06N 20/00

(57) ABSTRACT

Disclosed herein is an apparatus and method for decentralized federated learning. The method may include acquiring an initialized global model and federated learning parameters, which include list information of participating nodes and model training information, setting the global model as the local model to be trained with local data, training the local model by repeatedly performing a learning sub-round a predetermined number of time at each of the participating nodes, selecting an optimal local model from among the local models of the participating nodes, and setting the selected optimal local model as a new global model.

### CROSS REFERENCE TO RELATED APPLICATION

This application claims the benefit of Korean Patent Application No. 10-2025-0052040, filed Apr. 22, 2025, which is hereby incorporated by reference in its entirety into this application.

### BACKGROUND OF THE INVENTION

### 1. Technical Field

The disclosed embodiment relates generally to training technology for training machine learning models, and more particularly to decentralized federated learning technology that performs federated learning without requiring a dedicated central server for model aggregation.

### 2. Description of Related Art

Today, Artificial Intelligence (AI) technology is driving innovation across various fields. For AI-based innovation, trained machine-learning models are employed, and the quality of training data is a critical factor influencing the performance of the trained models.

However, securing high-quality data is often difficult due to concerns regarding the leakage of sensitive information. For example, sensitive information that is difficult to obtain but essential for constructing high-quality datasets may include medical information (e.g., diagnoses, medication history, family history of diseases, etc.), financial information (e.g., salary, savings, debts, a payment history, a creditworthiness, etc.), personal information (e.g., interests, political/religious beliefs, sexual orientation, etc.), and corporate secrets (e.g., clinical trial results for new drugs, market analysis results, toxicity analysis results, etc.).

Federated learning has been developed as a method for uniting terminals (servers) to train machine-learning models securely without disclosing such sensitive information, and has attracted attention as an innovative approach to data security and distributed processing for machine-learning model training.

Unlike conventional machine learning model training in which data is centralized, federated learning is configured to generate local models by training machine learning models on individual nodes that own their data, and to construct a single global model by integrating the local models trained on the individual nodes. Then, the global model is propagated back to the individual nodes to be further trained with local data, and the process of improving the model in this way is repeated. The federated learning enables efficient model training while preventing sensitive information leakage, which may occur due to data transfer.

Meanwhile, one of the challenges that federated learning technology must address is the communication load that arises during the creation of a single global model by aggregating trained local models. The communication load includes not only the frequency of communication (message transmission) during the training process, but also the total volume of transmitted data and the peak instantaneous transmission volume (network bandwidth).

In particular, in decentralized federated learning, each local server broadcasts its local model to multiple other local servers in order to construct a global model without a central server in the aggregation process, which results in a rapid increase in the amount of data transmitted at once.

### SUMMARY OF THE INVENTION

An object of the disclosed embodiment is to reduce communication load, especially the instantaneous transmission data volume, in federated learning for securely training machine-learning models without leakage of sensitive information.

A method for decentralized federated learning according to an embodiment may comprise acquiring federated learning parameters including list information of participating nodes and model training information and an initialized global model, setting the global model as a local model to be trained with local data, training the local model by repeatedly performing a learning sub-round a predetermined number of times at each of the participating nodes, selecting an optimal local model from among local models of the participating nodes, and setting the selected optimal local model as a new global model.

Here, the learning sub-round may be repeatedly performed a number of times equal to the number of participating nodes or a predetermined multiple of the number of participating nodes in each federated learning round.

Here, training the local model may include training the local model using local data held by the corresponding node, extracting performance information of the trained local model, selecting a first participating node to receive the trained local model from the corresponding node and a second participating node to deliver its local model to the corresponding node when a current sub-round is not the last learning sub-round, delivering the trained local model of the corresponding node to the first participating node and receiving the local model from the second participating node, and aggregating the local model received from the second participating node with the local model of the corresponding node.

Here, the performance information may include performance of a current local model and the degree of performance improvement compared to its previous performance, and the degree of performance improvement may reflect the contribution of a model trained on an additional participating node.

Here, delivering the local model and receiving the local model may comprise storing the local model in a file system and delivering or receiving location information of the stored local model, and a security method, including public-key cryptography, differential privacy, and blockchain, may be applied.

Here, aggregating the local model may comprise measuring performance of the received local model and aggregating the local model when the measured performance is equal to or higher than a certain level.

Here, selecting the first and second participating nodes may include generating a doubly circular linked list based on the list information of the participating nodes, selecting an n-th node counterclockwise from a position of the corresponding node in the doubly circular linked list as the first participating node to which the local model trained on the corresponding node is to be delivered in an n-th learning sub-round, and selecting an n-th node clockwise from the position of the corresponding node in the doubly circular linked list as the second participating node to deliver the local model trained thereon to the corresponding node in the n-th learning sub-round.

Here, selecting the optimal local model may include collecting performance information of the local model trained on the corresponding node and information about the degree of performance improvement when a local model received from other participating node is aggregated, delivering the collected information to other participating nodes, calculating an optimal model attractiveness based on both the information collected in the corresponding node and information received from other participating nodes, and selecting a local model of a participating node having the highest optimal model attractiveness as the optimal local model.

Here, the optimal model attractiveness may be calculated for each node by combining the performance of the local model with the contribution of the local model transmitted from the corresponding node to performance improvement on other nodes, according to a preset ratio.

Here, setting the new global model may comprise, when the local model of the corresponding node is selected as the optimal local model, delivering the optimal local model to the other participating nodes and setting the local model of the corresponding node as the new global model, and when the local model of the corresponding node is not selected as the optimal local model, setting the optimal local model received from a participating node having the optimal local model as the new global model.

An apparatus for decentralized federated learning according to an embodiment includes memory in which at least one program is recorded and a processor for executing the program, and the program may acquire federated learning parameters, including list information of participating nodes and model training information, and an initialized global model, set the global model as a local model to be trained with local data, train the local model by repeatedly performing a learning sub-round a predetermined number of times, select an optimal local model from among local models trained on the respective participating nodes, and set the selected optimal local model as a new global model.

Here, the learning sub-round may be repeatedly performed a number of times equal to the number of participating nodes or a predetermined multiple of the number of participating nodes in each federated learning round.

Here, when training the local model, the program may train the local model using local data held by a corresponding node, extract performance information of the trained local model, select a first participating node to receive the trained local model from the corresponding node and a second participating node to deliver a local model trained thereon to the corresponding node when a current sub-round is not the last learning sub-round, deliver the local model of the corresponding node to the first participating node, receive the local model from the second participating node, and aggregate the local model received from the second participating node with the local model of the corresponding node.

Here, the performance information may include performance of a current local model and the degree of performance improvement compared to previous performance, and the degree of performance improvement compared to the previous performance may reflect the contribution of a model trained on an additional node to the performance improvement.

Here, when delivering or receiving the local model, the program may store the local model in a file system, deliver or receive location information of the stored local model, and apply a security method, including public-key cryptography, differential privacy, and blockchain.

Here, when aggregating the local model, the program may measure performance of the received local model and may aggregate the local model when the measured performance is equal to or higher than a certain level.

Here, the program may generate a doubly circular linked list based on the list information of the participating nodes, select an n-th node counterclockwise from a position of the corresponding node in the doubly circular linked list as the first participating node to which the local model trained on the corresponding node is to be delivered in an n-th learning sub-round, and select an n-th node clockwise from the position of the corresponding node in the doubly circular linked list as the second participating node to deliver the local model trained thereon to the corresponding node in the n-th learning sub-round.

Here, when selecting the optimal local model, the program may collect performance information of a local model trained on a corresponding node and information about the degree of performance improvement when a local model received from an additional participating node is aggregated, deliver the collected information to the other participating nodes, calculate an optimal model attractiveness based on both the information collected in the corresponding node and information received from the other participating nodes, and select a local model of a participating node having the highest optimal model attractiveness as the optimal local model.

Here, the optimal model attractiveness may be calculated for each node by combining the performance of the local model with the contribution of the local model transmitted from the corresponding node to performance improvement on the other nodes, according to a preset ratio.

Here, when setting the new global model, if a local model of a corresponding node is selected as the optimal local model, the optimal local model may be delivered to other participating nodes and the local model of the corresponding node may be set as the new global model, but if the local model of the corresponding node is not selected as the optimal local model, the optimal local model received from the participating node having the optimal local model may be set as the new global model.

### BRIEF DESCRIPTION OF THE DRAWINGS

The above and other objects, features, and advantages of the present disclosure will be more clearly understood from the following detailed description taken in conjunction with the accompanying drawings, in which:

FIGS. 1 to 3 are exemplary views for explaining various federated learning methods for creating a global model;

FIG. 4 is a schematic configuration diagram of a decentralized federated learning system to which an embodiment is applied;

FIG. 5 is a flowchart for explaining a decentralized federated learning method in a participating node according to an embodiment;

FIG. 6 is a flowchart for explaining in detail a learning sub-round according to an embodiment;

FIG. 7 is a flowchart for explaining in detail a step of selecting the participating node to deliver or receive a global model according to an embodiment;

FIG. 8 is an exemplary view of a doubly circular linked list of participating nodes according to an embodiment;

FIG. 9 is an exemplary view of selecting a node from a doubly circular linked list of participating nodes according to an embodiment;

FIG. 10 is a flowchart for explaining in detail a step of selecting an optimal local model according to an embodiment;

FIG. 11 is a flowchart for explaining in detail a step of setting a selected local model as a global model according to an embodiment;

FIG. 12 is an exemplary view of information that is shared among all participating nodes in order to select an optimal local model according to an embodiment;

FIG. 13 is an exemplary view for explaining decentralized federated learning according to an embodiment; and

FIG. 14 is a view illustrating a computer system configuration according to an embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

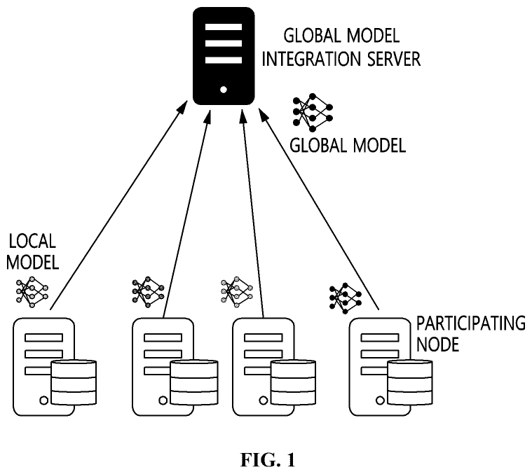

FIGS. 1 to 3 are exemplary views for explaining various federated learning methods for creating a global model.

Federated Learning (referred to as “FL” hereinbelow) methods may be classified into centralized FL, decentralized FL, and hierarchical FL depending on the coordination method for creating a global model.

Referring to FIG. 1, centralized FL is a method in which a central integration server dedicated to global model creation creates a global model by receiving and aggregating local models trained on federated learning participating nodes.

Referring to FIG. 2, decentralized FL is a method of creating a global model by exchanging local models between participating nodes and aggregating the local models in the participating nodes, without a separate server dedicated to global model creation.

Referring to FIG. 3, hierarchical FL is a method in which participating nodes are divided into groups and local servers, each of which serves to aggregate training results of the participating nodes in each group, are placed between the participating nodes and a global server, whereby a global model may be created through gradual aggregation via multiple intermediate layers.

Also, federated learning may be classified into cross-silo FL and cross-device FL depending on the size and capability (specifications, computational abilities, etc.) of participating nodes (devices).

In the case of cross-silo FL, each participating node has high capability, but the number of nodes participating in learning is relatively small. In the case of cross-device FL, each participating node has low capability, but the number of nodes participating in learning is very large.

Also, federated learning may be classified into horizontal FL and vertical FL depending on the characteristics of the data composition at each participating node.

In the case of horizontal FL, data of participating nodes has identical feature spaces but varying sample spaces, and in the case of vertical FL, data shares the same sample space but differs in feature spaces.

In a cross-silo environment, participating nodes belong to organizations of the same level, so it is not easy to integrate a global model through a single central server of any specific organization.

The disclosed embodiment proposes an apparatus and method for efficient decentralized federated learning in a cross-silo environment.

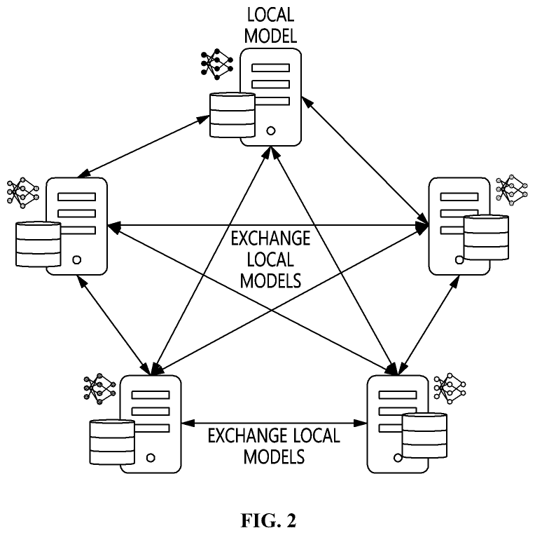

FIG. 4 is a schematic configuration diagram of a decentralized federated learning system to which an embodiment is applied.

Referring to FIG. 4, in the decentralized federated learning system according to an embodiment, multiple learning participating nodes 10 are grouped together and form a federated learning participating node group 1.

The participating nodes 10 are interconnected through a communication network 2 and are able to access a distributed file system 3.

Also, the participating node 10 includes a federated learning controller 11, which controls performing federated learning, and a machine learning framework 12, which performs model training.

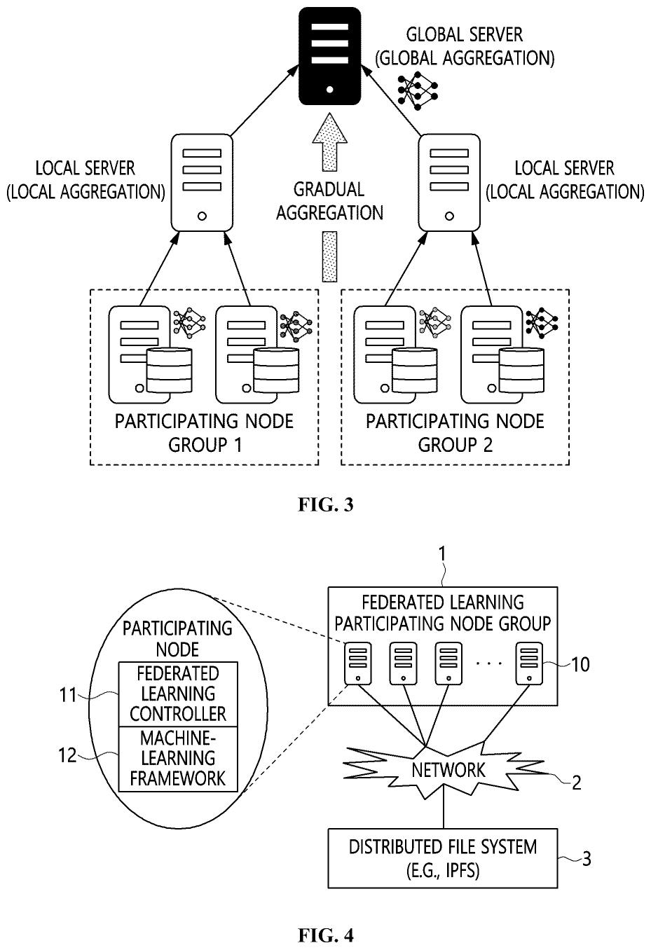

FIG. 5 is a flowchart for explaining a decentralized federated learning method in a participating node according to an embodiment.

Referring to FIG. 5, the federated learning controller 11 of a federated learning participating node 10 according to an embodiment receives federated learning parameters at step S100.

Here, the federated learning parameters include information about nodes participating in federated learning, information for model training, and the like.

Here, the information about the nodes participating in federated learning may be in the form of an ordered list.

For federated learning, the federated learning controller 11 initializes a global model w_{g} (weight initialization) at step S200 and repeatedly performs a federated learning round at steps S300 to S600.

Specifically, in order to perform the federated learning round, the federated learning controller 11 sets the global model w_{g} as a local model wₗ to be trained with local data (wₗ←w_{g}) at step S300 and trains the local model wₗ by repeatedly performing a learning sub-round at step S400.

Subsequently, the federated learning controller 11 selects an optimal local model wₒₚₜ from among the local models of the participating nodes at step S500, obtains the selected optimal local model wₒₚₜ, and sets the optimal local model wₒₚₜ as a new global model w_{g} (w_{g}←wₒₚₜ) at step S600.

All the participating nodes train the model by repeatedly performing the above-described federated learning round at steps S300 to S600.

The learning sub-round at step S400 may be performed in each participating node.

According to an embodiment, the learning sub-round may be repeatedly performed as many times as the number of participating nodes in each federated learning round.

Also, according to another embodiment, the learning sub-round may be repeatedly performed as many times as a certain multiple of the number of participating nodes.

Here, the number of iterations of the learning sub-round may be determined based on a federated learning parameter that is set to a multiple of the number of participating nodes when federated learning is requested.

Hereinafter, a description will be made on the assumption that the learning sub-round is repeatedly performed as many times as the number of participating nodes for the convenience of description.

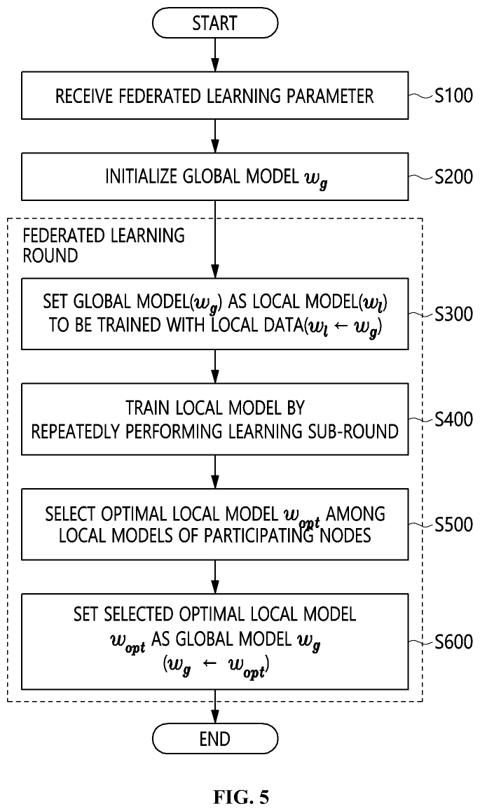

FIG. 6 is a flowchart for explaining in detail a learning sub-round according to an embodiment.

Referring to FIG. 6, the federated learning controller 11 of a participating node 10 first trains a local model wₗ using local data of the node at step S410 and extracts performance information of the trained local model at step S420.

Here, the performance information of the local model includes not only the performance of the current local model but also the degree of performance improvement compared to its previous performance.

Here, it can be seen that the degree of performance improvement compared to the previous performance has reflected the contribution of a model trained on another node to the overall performance improvement.

Subsequently, the federated learning controller 11 of the participating node 10 checks whether the current sub-round is the last learning sub-round based on the preset number of iterations of the learning sub-round at step S430.

Here, according to an embodiment, the number of iterations of the learning sub-round may be equal to the number of participating nodes.

Also, according to another embodiment, the number of iterations of the learning sub-round may be set to a multiple of the number of participating nodes, which is passed as a parameter when federated learning is requested.

If it is determined at step S430 that the current sub-round is not the last learning sub-round, the federated learning controller 11 of the participating node 10 performs steps S440 to S470, thereby reflecting the result of training using data of another participating node to the local model thereof.

Specifically, the federated learning controller 11 selects the participating node Nₛ to receive the trained local model from the corresponding participating node 10 and the participating node Nₚ to deliver the local model trained thereon to the corresponding participating node at step S440.

Subsequently, the federated learning controller 11 delivers the trained local model to the selected participating node Nₛ at step S450 and receives the local model trained on the participating node Nₚ at step S460.

Subsequently, the federated learning controller 11 aggregates the local model of the corresponding node with the local model received from Ny at step S470 and terminates one learning sub-round at step S480.

On the other hand, if it is determined at step S430 that the current sub-round is the last learning sub-round, the federated learning controller 11 terminates the learning sub-round at step S480.

According to an embodiment, in each learning sub-round, a local model trained on another participating node is aggregated, whereby training using the data of other participating nodes is progressively reflected in the local model.

As an embodiment of model transfer at steps S450 to S460 in the flow of the learning sub-round, a method of directly transmitting the trained local model through a network connection may be used.

Alternatively, according to another embodiment, a method of storing the trained local model in a file system and notifying the location information of the stored local model may be used.

Here, various methods (e.g., public-key cryptography, differential privacy, etc.) may be used to prevent data from being tampered or exposed by individuals or groups with malicious purposes. Alternatively, a blockchain system may be used as another embodiment for model transfer.

Meanwhile, at step S470, the performance of the received model is measured, and if the measured performance is equal to or lower than a certain level, the model may not be aggregated.

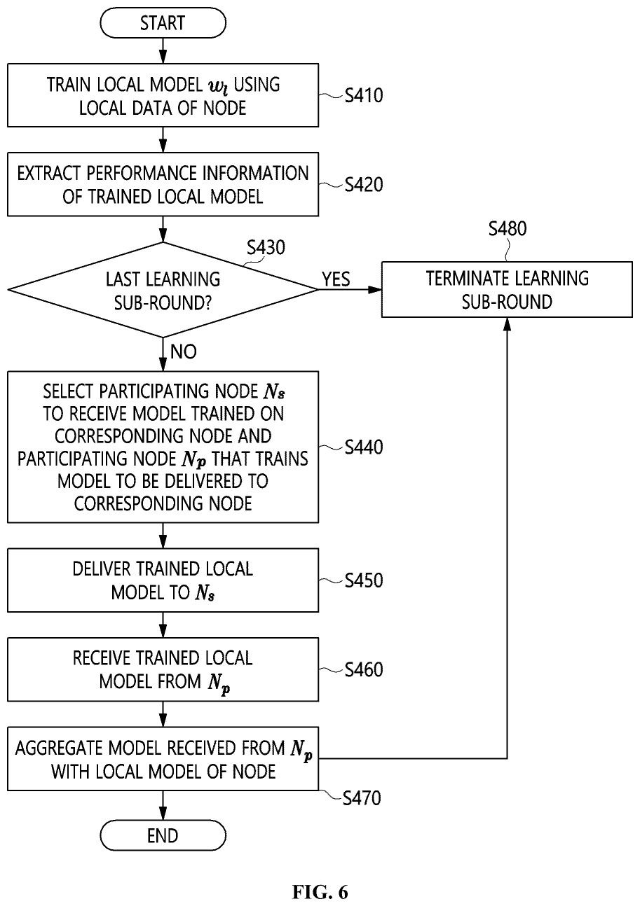

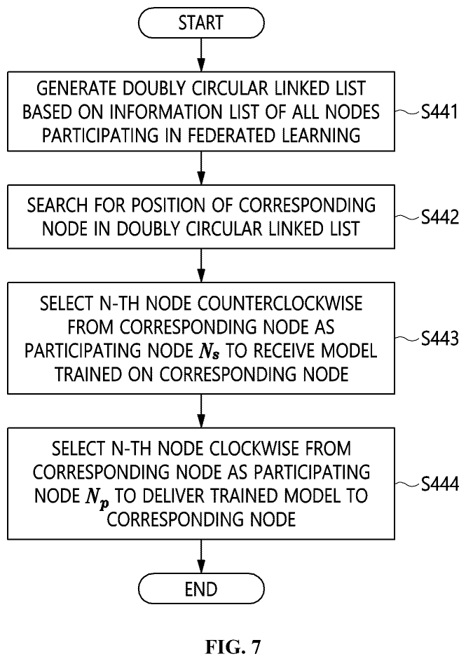

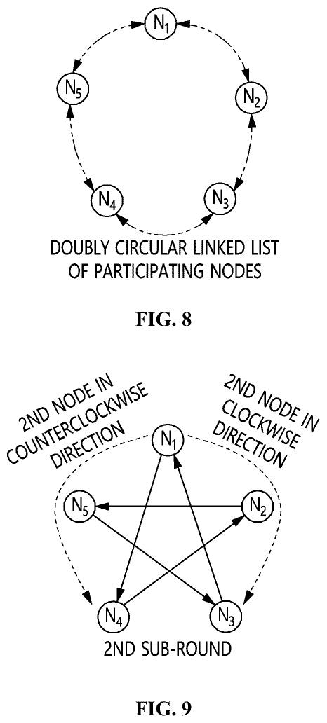

FIG. 7 is a flowchart for explaining in detail a step of selecting a participating node to deliver or receive a global model according to an embodiment, FIG. 8 is an exemplary view of a doubly circular linked list of participating nodes according to an embodiment, and FIG. 9 is an exemplary view of selecting a node from a doubly circular linked list of participating nodes according to an embodiment.

FIG. 7 illustrates an embodiment of the step (S440) of selecting the node Nₛ to receive a trained model from a corresponding node and the node Nₚ to deliver a trained model thereof to the corresponding node in the n-th learning sub-round in the flow of the learning sub-round according to an embodiment.

In order to select the nodes involved in model transfer, the federated learning controller 11 generates a doubly circular linked list based on an information list about all nodes participating in federated learning, which is provided as an argument, at step S441.

For example, FIG. 8 illustrates a doubly circular linked list of participating nodes when five nodes, including N₁, N₂, N₃, N₄, and N₅, participate in federated learning.

Subsequently, the federated learning controller 11 searches for the position of the node, including itself, in the doubly circular linked list at step S442, selects the n-th node counterclockwise from the corresponding node as the participating node Nₛ to which the model trained on the corresponding node is to be delivered in the n-th learning sub-round at step S443, and selects the n-th node clockwise from the position of the corresponding node as the participating node Nₚ to deliver the trained model thereof to the corresponding node in the n-th learning sub-round at step S444.

For example, referring to FIG. 9, the model transfers from each node in the second learning sub-round are illustrated using arrows. That is, in the second learning sub-round, the participating node N₁ delivers its trained model to N₄, which is the second node in the counterclockwise direction, receives the model trained on N₃, which is the second node in the clockwise direction, and uses the received model in the next learning sub-round.

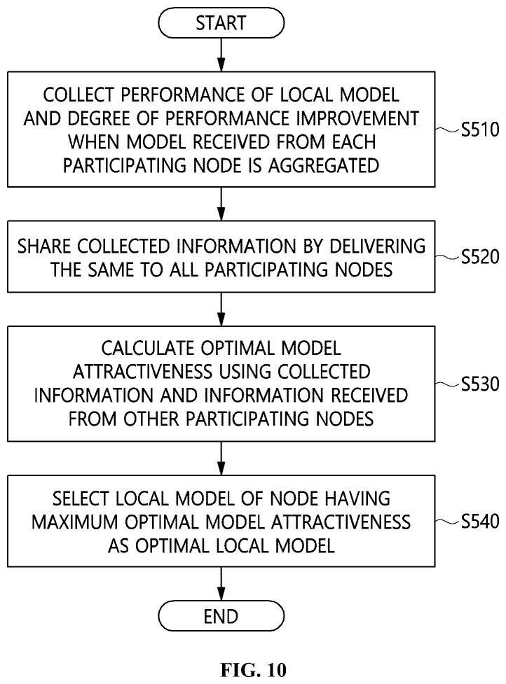

FIG. 10 is a flowchart for explaining in detail a step (S500) of selecting an optimal local model according to an embodiment.

Referring to FIG. 10, in order to select the optimal local model, the federated learning controller 11 of each participating nodes collects the performance information of the local model trained on the corresponding node and information about the degree of performance improvement (change) when the local model received from another participating node is aggregated at step S510.

Here,

$${C}_{k}^{i} ,$$

which represents the degree of performance improvement on node Nᵢ after aggregation with the local model received from node Nₖ, is defined as the difference in the performance on node Nᵢ in the sub-round between before and after aggregation with the local model received from node Nₖ, and when i and k are equal to each other, it is set to 0 for convenience.

Because

$${C}_{k}^{i}$$

has reflected the effect of the local model received from node Nₖ, this is regarded as the contribution of node Nₖ to the performance improvement on node Nᵢ.

The federated learning controller 11 delivers the collected information to all the participating nodes and shares it with them at step S520.

Accordingly, the federated learning controller 11 calculates an optimal model attractiveness using the information collected thereby and the information received from other participating nodes at step S530.

Here, the optimal model attractiveness is calculated for each node by combining the performance of the local model of the corresponding node with the contribution of the local model transmitted from the corresponding node to the performance improvement on other nodes, according to a preset ratio.

The optimal model attractiveness Aₖ of participating node Nₖ may be represented as shown in Equation (1) below:

$${A}_{k} = α {P}_{k} + ( 1 - α ) {\sum }_{i = 1}^{n} {C}_{k}^{i} \qquad ( 1 )$$

In Equation (1), Pk represents the performance of the current local model of node Nₖ,

$${C}_{k}^{i}$$

denotes the degree of performance improvement on node Nᵢ after aggregation with the local model received from node Nₖ, and α denotes a weight ratio for the performance of the local model.

According to an embodiment of the present disclosure, the weight ratio for local node performance, a, is a value that can be set by passing the same as an argument when federated learning is requested.

Subsequently, the federated learning controller 11 selects the local model of the node with the largest optimal model attractiveness Aₖ as the optimal local model at step S540.

Here, when two or more nodes have the largest optimal model attractiveness, the node that more affects the performance improvement on other nodes (i.e., the node that has made a larger contribution) is regarded as having a higher attractiveness.

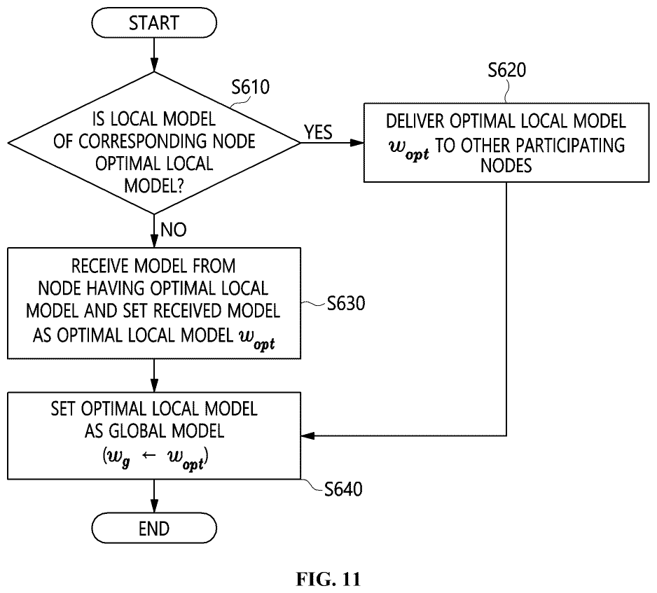

FIG. 11 is a flowchart for explaining in detail a step of setting a selected local model as a global model according to an embodiment.

Referring to FIG. 11, the federated learning controller 11 checks at step S610 whether its local model wₗ thereof has been selected as the optimal local model wₒₚₜ as a result of selecting the optimal local model performed in step S500.

When the local model wₗ is determined to be the optimal local model wₒₚₜ at step S610, the federated learning controller 11 delivers the optimal local model wₒₚₜ to the other participating nodes at step S620 and sets the optimal local model wₒₚₜ as a global model w_{g} (w_{g}←wₒₚₜ) at step S640.

Conversely, when the local model wₗ is not the optimal local model at step S610, the federated learning controller 11 receives the optimal local model from the node having the optimal local model, sets the received model as the optimal local model wₒₚₜ at step S630, and sets the optimal local model wₒₚₜ as a global model (w_{g}←wₒₚₜ) at step S640.

In order to clarify the flow of selecting the optimal local model at step S500 and setting the selected local model as a global model at step S600, an example of shared information is described below.

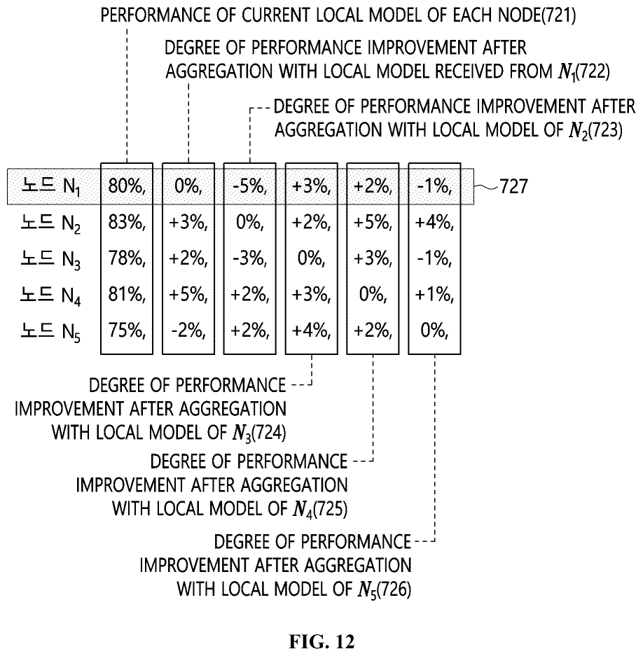

FIG. 12 is an exemplary view of information shared among all participating nodes in order to select an optimal local model according to an embodiment.

Referring to FIG. 12, it is assumed that five nodes, including N₁, N₂, N₃, N₄, and N₅, participate in federated learning.

In an embodiment, the shared information is represented as {the performance of the current local model (721), the degree of performance improvement after aggregation with the local model received from node N₁ (722), the degree of performance improvement after aggregation with the local model received from node N₂ (723), the degree of performance improvement after aggregation with the local model received from node N₃ (724), the degree of performance improvement after aggregation with the local model received from node N₄ (725), the degree of performance improvement after aggregation with the local model received from node N₅ (726)} for each node.

In an embodiment, (80%, 0%, −5%, +3%, +2%, −1%) indicated by 727 represents information collected and shared by node N₁. This means that the performance of the current local model trained on the current node, N₁, is 80% and that the performance is improved by −5% after aggregation with the local model received from node N₂, by +3% after aggregation with the local model received from node N₃, by +2% after aggregation with the local model received from node N₄, and by −1% after aggregation with the local model received from node N₅.

Based on the information in FIG. 12, the optimal model attractiveness, Aₖ, of each node according to an embodiment is calculated using Equation (1) by assigning equal weights (0.5:0.5) to the local model performance and the contribution to the performance improvement on other nodes as follows.

$${A}_{1} = 0.5 * 80 + 0.5 * ( 0 + 3 + 2 + 5 - 2 ) = 44.$$

$${A}_{2} = 0.5 * 83 + 0.5 * ( - 5 + 0 - 3 + 2 + 2 ) = 39.5$$

$${A}_{3} = 0.5 * 78 + 0.5 * ( 3 + 2 + 0 + 3 + 4 ) = 45.$$

$${A}_{4} = 0.5 * 81 + 0.5 * ( 2 + 5 + 3 + 0 + 2 ) = 46.5$$

$${A}_{5} = 0.5 * 75 + 0.5 * ( - 1 + 4 - 1 + 1 + 0 ) = 39.$$

According to an embodiment, the local model of N₄, which has the largest optimal model attractiveness Aₖ, is selected as the optimal local model. N₄, which is the node with the optimal local model, propagates the local model thereof to the other nodes as a global model, and the other nodes (N₁, N₂, N₃, and N₅) set the model transmitted from N₄ as the global model and continuously perform federated learning by repeating the federated learning rounds at steps S300 to S600 illustrated in FIG. 5.

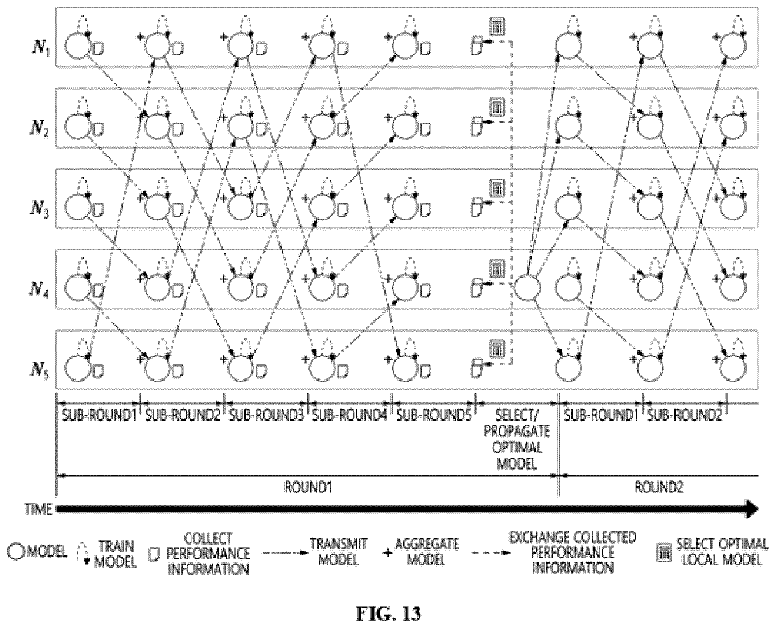

FIG. 13 is an exemplary view of explaining decentralized federated learning according to an embodiment.

In FIG. 13, it is assumed that five nodes, including N₁, N₂, N₃, N₄, and N₅, participate in federated learning.

Each learning round d includes five learning sub-rounds and selection/propagation of the optimal model. In each sub-round, a local model is trained based on data held by a node, and performance information is collected using the trained model. Also, the model trained in the sub-round is delivered to another node and aggregated. Performing the next sub-round using the aggregated model is repeated. After five sub-rounds, the performance information collected in each sub-round is shared with all participating nodes in order to select the optimal local model. Each node selects a model trained on a specific node (e.g., N₄) as the optimal local model based on the performance information collected and shared, and the node with the optimal local model (e.g., N₄) propagates the model to other nodes as a global model, whereby one learning round is completed. The learning round is repeated until the condition for terminating model training is satisfied.

As described above, in the disclosed embodiment, instead of delivering collected local models to all participating nodes at once in order to create a global model as in typical decentralized federated learning, each trained local model is delivered to one neighboring node and aggregated in each learning sub-round, and then the next learning sub-round proceeds. By aggregation with the local model trained on another participating node in each sub-round, training using data of other participating nodes may be incrementally reflected, which has the advantage of significantly reducing the instantaneous traffic (i.e., the amount of the transmitted data) for global model creation, which is a communication load problem caused by delivering the trained local models to all participating nodes at once to create a global model in the existing typical decentralized federated learning method.

The present disclosure proposes technology for addressing the communication load problem in decentralized federated learning, but those having knowledge in the related art will be able to easily extend and apply the technology in the process of creating a global integration model using a local integration model in hierarchical federated learning.

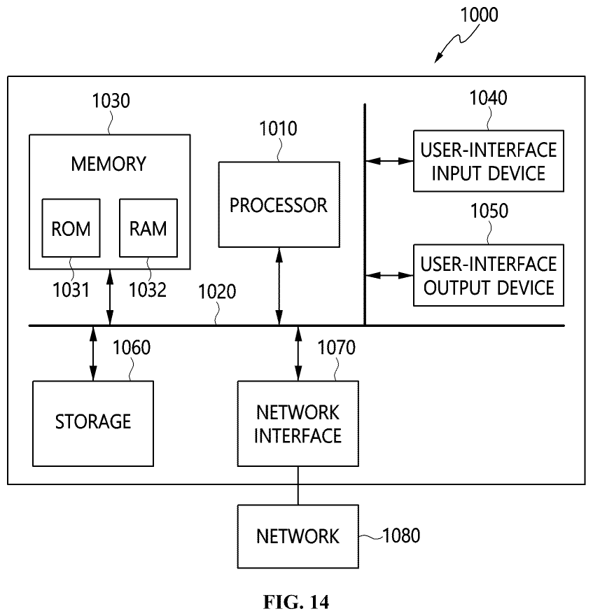

FIG. 14 is a view illustrating a computer system configuration according to an embodiment.

The apparatus for decentralized federated learning according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected with a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

According to the disclosed embodiment, communication load, especially the instantaneous transmission data volume, may be reduced in federated learning for securely training machine-learning models without sensitive information leakage.

Although the embodiments of the present disclosure have been described with reference to the accompanying drawings, those skilled in the art will appreciate that the present disclosure may be practiced in other specific forms without changing the technical spirit or essential features of the present disclosure. Therefore, the embodiments described above are illustrative in all aspects and should not be understood as limiting the present disclosure.

What is claimed is:

1. A method for decentralized federated learning, comprising:
acquiring federated learning parameters, including list information of participating nodes and model training information, and an initialized global model;
setting the global model as a local model to be trained with local data;
training the local model by repeatedly performing a learning sub-round a predetermined number of times at each of the participating nodes;
selecting an optimal local model from among local models of the participating nodes; and
setting the selected optimal local model as a new global model.

2. The method of claim 1, wherein, in each federated learning round, the learning sub-round is repeatedly performed a number of times equal to a number of participating nodes or a predetermined multiple of the number of participating nodes.

3. The method of claim 1, wherein training the local model comprises:
training the local model using local data held by the corresponding node;
extracting performance information of the trained local model;
selecting a first participating node to receive the trained local model from the corresponding node and a second participating node to deliver its local model to the corresponding node when a current sub-round is not a last learning sub-round;
delivering the trained local model of the corresponding node to the first participating node and receiving the local model from the second participating node; and
aggregating the local model received from the second participating node with the local model of the corresponding node.

4. The method of claim 3, wherein:
the performance information includes performance of a current local model and a degree of performance improvement compared to its previous performance, and
the degree of performance improvement reflects a contribution of a model trained on an additional participating node.

5. The method of claim 3, wherein:
delivering the local model and receiving the local model comprises storing the local model in a file system and delivering or receiving location information of the stored local model, and
a security method, including public-key cryptography, differential privacy, and blockchain, is applied.

6. The method of claim 3, wherein aggregating the local model comprises measuring performance of the received local model and aggregating the local model when the measured performance is equal to or higher than a certain level.

7. The method of claim 3, wherein selecting the first and second participating nodes comprises:
generating a doubly circular linked list based on the list information of the participating nodes;
selecting an n-th node counterclockwise from a position of the corresponding node in the doubly circular linked list as the first participating node to which the local model trained on the corresponding node is to be delivered in an n-th learning sub-round; and
selecting an n-th node clockwise from the position of the corresponding node in the doubly circular linked list as the second participating node to deliver the local model trained thereon to the corresponding node in the n-th learning sub-round.

8. The method of claim 1, wherein selecting the optimal local model comprises:
collecting performance information of the local model trained on the corresponding node and information about a degree of performance improvement when a local model received from other participating node is aggregated;
delivering the collected information to other participating nodes;
calculating an optimal model attractiveness based on both the information collected in the corresponding node and information received from other participating nodes; and
selecting a local model of a participating node having the highest optimal model attractiveness as the optimal local model.

9. The method of claim 8, wherein the optimal model attractiveness may be calculated for each node by combining the performance of the local model with the contribution of the local model transmitted from the corresponding node to performance improvement on other nodes, according to a preset ratio.

10. The method of claim 1, wherein setting the new global model comprises:
when the local model of the corresponding node is selected as the optimal local model, delivering the optimal local model to the other participating nodes and setting the local model of the corresponding node as the new global model; and
when the local model of the corresponding node is not selected as the optimal local model, setting the optimal local model received from a participating node having the optimal local model as the new global model.

11. An apparatus for decentralized federated learning, comprising:
memory in which at least one program is recorded; and
a processor for executing the program,
wherein the program acquires federated learning parameters, including list information of participating nodes and model training information, and an initialized global model, sets the global model as a local model to be trained with local data, trains the local model by repeatedly performing a learning sub-round a predetermined number of times, selects an optimal local model from among local models trained on the respective participating nodes, and set the selected optimal local model as a new global model.

12. The apparatus of claim 11, wherein, in each federated learning round, the learning sub-round is repeatedly performed a number of times equal to a number of participating nodes or a predetermined multiple of the number of participating nodes.

13. The apparatus of claim 11, wherein, when training the local model, the program trains the local model using local data held by a corresponding node, extracts performance information of the trained local model, selects a first participating node to receive the trained local model from the corresponding node and a second participating node to deliver a local model trained thereon to the corresponding node when a current sub-round is not a last learning sub-round, delivers the local model of the corresponding node to the first participating node, receives the local model from the second participating node, and aggregates the local model received from the second participating node with the local model of the corresponding node.

14. The apparatus of claim 13, wherein:
the performance information includes performance of a current local model and a degree of performance improvement compared to previous performance, and
the degree of performance improvement compared to the previous performance reflects a contribution of a model trained on an additional participating node to the performance improvement.

15. The apparatus of claim 13, wherein, when delivering or receiving the local model, the program stores the local model in a file system, delivers or receives location information of the stored local model, and applies a security method, including public-key cryptography, differential privacy, and blockchain.

16. The apparatus of claim 13, wherein, when aggregating the local model, the program measures performance of the received local model and aggregates the local model when the measured performance is equal to or higher than a certain level.

17. The apparatus of claim 13, wherein the program generates a doubly circular linked list based on the list information of the participating nodes, selects an n-th node counterclockwise from a position of the corresponding node in the doubly circular linked list as the first participating node to which the local model trained on the corresponding node is to be delivered in an n-th learning sub-round, and selects an n-th node clockwise from the position of the corresponding node in the doubly circular linked list as the second participating node to deliver the local model trained thereon to the corresponding node in the n-th learning sub-round.

18. The apparatus of claim 11, wherein, when selecting the optimal local model, the program may collect performance information of a local model trained on a corresponding node and information about the degree of performance improvement when a local model received from an additional participating node is aggregated, deliver the collected information to the other participating nodes, calculate an optimal model attractiveness based on both the information collected in the corresponding node and information received from the other participating nodes, and select a local model of a participating node having the highest optimal model attractiveness as the optimal local model.

19. The apparatus of claim 18, wherein the optimal model attractiveness may be calculated for each node by combining the performance of the local model with the contribution of the local model transmitted from the corresponding node to performance improvement on the other nodes, according to a preset ratio.

20. The apparatus of claim 11, wherein, when setting the new global model,
if a local model of a corresponding node is selected as the optimal local model, the optimal local model is delivered to other participating nodes and the local model of the corresponding node is set as the new global model, but
if the local model of the corresponding node is not the optimal local model, the optimal local model received from the participating node having the optimal local model may be set as the new global model.
